(19) United States
(12) Patent Application Publication
(10) Pub. No.: US 2010/0052409 A1
(43) Pub. Date: Mar. 4, 2010

(54) TRANSPORTATION VEHICLE

(75) Inventor: Jun IKEDA, Tsuchiura-shi (JP)

Correspondence Address: MATTINGLY & MALUR, P.C., 1800 DIAGONAL ROAD, SUITE 370, ALEXANDRIA, VA, 22314, US

(73) Assignee: HITACHI CONSTRUCTION MACHINERY CO., LTD., Tokyo (JP)

(21) Appl. No.: 12/540,455

(22) Filed: Aug. 13, 2009

(30) Foreign Application Priority Data
Aug. 28, 2008 (JP) 2008-220016

(51) Int. Cl. B60B 25/04

(52) U.S. Cl. 301/13.2

(57) ABSTRACT

An outside diameter of a rim spacer of a vehicle wheel is formed with an equal outside diameter dimension to those of fringe portions and of an outer rim making it possible to prevent a step from being produced between the fringe portion of the outer rim and the rim spacer. An abutment portion of an inner rim has an outside diameter formed with an equivalent diameter to the outside diameter of the rim spacer to prevent a step from being produced therebetween. This prevents an inner tire from being inclined diagonally between the inner rim and the rim spacer and also prevents a bead seat band and the like of the inner tire from being caught between the outer rim and the rim spacer.

### BACKGROUND OF THE INVENTION

1. Field of the Invention

The present invention relates to a transportation vehicle which is suitably used for loading and transporting a cargo consisting of such as crushed stones excavated from a mine or the like or dug earth and sand.

2. Description of the Related Art

In general, transportation vehicles such as dump trucks are used for transporting to a desired place such as crushed stones excavated from a mine or earth and sand dug by using a hydraulic excavator. Such a transportation vehicle has a liftable vessel (loading platform) on a frame of a vehicle body, and transports the cargo consisting of such as crushed stones or earth and sand with the cargo loaded on the vessel.

In addition, the transportation vehicle according to this type of the prior art has a tubular axle housing provided on a lower side of the vehicle body in such a manner as to extend in a left-right direction, a pair of tubular wheel mounting cylinders respectively provided on both axial end sides of the axle housing, and left and right wheels which rotate integrally with the respective wheel mounting cylinders. Each of these wheels has a plurality of rim bases provided on an outer peripheral surface side of the wheel mounting cylinder and arranged at an interval in the left-right direction and multiple tires which are respectively mounted by being detachably fitted to an outer peripheral surface side of the respective rim bases and rotate integrally with the wheel mounting cylinder (e.g., see Japanese Patent Laid-Open No. 2006-264395).

Namely, with the transportation vehicle according to this type of the prior art, since the weight of the cargo loaded on the vessel (loading platform) is mainly applied to the rear wheel side of the vehicle, multiple tires constituted by juxtaposing, for example, dual tires are used for the left and right rear wheels to thereby enable the reduction of the superimposed load per tire.

Incidentally, in the case of the transportation vehicle according to this type of the prior art, since the superimposed load ratio per tire can be reduced by using the multiple tires on the rear wheel side, there is an advantage in that the weight of the cargo loaded on the vessel (loading platform) can be increased. However, the outside diameter dimension of each tire is formed with a diameter as large as 2 to 4 meters, for example, and its weight is as large as 1 to 3 tons.

In addition, such multiple tires are arranged such that, for example, dual tires are respectively mounted by being fitted to a wheel mounting cylinder. For this reason, the operations of drawing out the respective tires in such a manner as to pull them out from the wheel mounting cylinder and of conversely remounting the tires to the wheel mounting cylinder at the time of periodic inspection require much time and trouble. Hence, there are problems in that the operational efficiency at the time of maintenance is poor, and that the burden on the operator is extremely large.

### SUMMARY OF THE INVENTION

In view of the above-described problems of the prior art, an object of the present invention is to provide a transportation vehicle which makes it possible to easily perform the mounting and dismounting operation of the multiple tires, thereby making it possible to improve the operational efficiency at the time of assembly and maintenance.

To accomplish the above-described object, the present invention is applied to a transportation vehicle comprising: a vehicle body on which a loading platform for carrying a load of transportation thereon is provided; a tubular axle housing provided on a lower side of the vehicle body in such a manner as to extend in a left-right direction; a pair of tubular wheel mounting cylinders respectively provided on both axial end sides of the axle housing; and left and right wheels which are respectively provided on the wheel mounting cylinders and rotate integrally with the wheel mounting cylinders, each of the wheels including a plurality of rim bases provided on an outer peripheral surface side of the wheel mounting cylinder and arranged at an interval in the left-right direction and multiple tires which are respectively mounted by being detachably fitted to an outer peripheral surface side of each one of the rim bases and rotate integrally with the wheel mounting cylinder.

Further, the characteristic feature of the construction adopted in the present invention lies in that a rim spacer disposed between the rim bases to secure a clearance in the left-right direction between the tires is provided on the outer peripheral surface side of the wheel mounting cylinder, and the rim spacer is formed with an equivalent outside diameter dimension to that of the rim base located on an outer side in the left-right direction between the rim bases.

According to this construction, it is possible to prevent a step (a step along the outer peripheral surface of the rim base and the rim spacer) from being produced between the rim spacer and the rim base located on the outer side. For this reason, at the time of dismounting the multiple tires from the wheel mounting cylinder, in the state in which the plurality of rim bases and the rim spacer are kept fixed to the wheel mounting cylinder, the multiple tires (inner and outer tires) can be smoothly pulled out and removed along their outer peripheral surfaces without being hampered by a step. Accordingly, the operations of mounting and dismounting the multiple tires with respect to the wheel mounting cylinder can be performed easily, thereby making it possible to substantially improve the operational efficiency at the time of assembly and maintenance and substantially alleviate such as the burden on the operator.

In addition, according to the present invention, a fitting ring which is slidably fitted on the outer peripheral surface side of the rim base is provided on an inside diameter side of at least the tire located at a position on an axially outer side of the wheel mounting cylinder between the multiple tires, and a lock ring which abuts against the fitting ring with an interference to effect the retaining of the tire is detachably provided on the outer peripheral surface side of the rim base.

With the arrangements just described, when the multiple tire is dismounted from the wheel mounting cylinder, the lock ring is first removed from the rim base, thereby making it possible to draw out the tire together with the fitting rings in such a manner as to pull them out along the outer peripheral surface of the rim base. On the other hand, when, conversely, the multiple tire is mounted by fitting in such a manner as to be slid together with the fitting ring along the outer peripheral surface of the rim base, the lock ring is finally mounted to the outer peripheral surface side of the rim base, which allows that lock ring to abut against the fitting ring with an interference, thereby making it possible to reliably perform the retention of the tire.

In addition, according to the present invention, the plurality of rim bases are provided by being fitted to an outer peripheral surface of the wheel mounting cylinder. This construction applies to a case where the rim base corresponds to a tire mounting rim of the so-called tapered type, and the tire can be detachably mounted to the outer peripheral surface side of the rim base fixed by being fitted to the outer periphery of the wheel mounting cylinder.

Furthermore, according to the present invention, an annular disk is integrally provided on an inner peripheral side of the plurality of rim bases respectively, and each of the rim bases is provided by being fixed to the wheel mounting cylinder by tightening the disk to an outer peripheral side of the wheel mounting cylinder.

This construction applies to a case where the rim base corresponds to a tire mounting rim of the so-called center disk type, and the tire can be detachably mounted to the outer peripheral surface side of the rim base fixed to the outer periphery of the wheel mounting cylinder through an annular disk.

### BRIEF DESCRIPTION OF THE DRAWINGS

FIG. 1 is a front elevational view illustrating a dump truck in accordance with a first embodiment of the present invention;

FIG. 2 is an enlarged sectional view, taken from the direction of arrows II-II in FIG. 1, of tires and the like on the rear wheel side;

FIG. 3 is an enlarged view of essential portions in FIG. 2 and illustrates a rim spacer and the like provided between an outer tire and an inner tire;

FIG. 4 is a sectional view, taken from the direction of arrows IV-IV in FIG. 2, of the rim spacer;

FIG. 5 is a partially sectional view illustrating a state in which a lock ring has been removed from an outer rim to dismount the outer tire from a wheel mounting cylinder;

FIG. 6 is a partially sectional view illustrating a state in which the outer tire has been drawn out from the wheel mounting cylinder in continuation from FIG. 5;

FIG. 7 is a partially sectional view illustrating a state in which another lock ring has been removed from the outer rim to dismount the inner tire from the wheel mounting cylinder in continuation from FIG. 6;

FIG. 8 is a partially sectional view illustrating a state in which still another lock ring has been removed from the inner rim to dismount the inner tire from the wheel mounting cylinder in continuation from FIG. 7;

FIG. 9 is a partially sectional view illustrating an interim state in which the inner tire is being drawn out from the wheel mounting cylinder in continuation from FIG. 8;

FIG. 10 is a partially sectional view illustrating a state in which the inner tire has been drawn out from the wheel mounting cylinder in continuation from FIG. 9;

FIG. 11 is an enlarged sectional view illustrating the rim spacer and the like provided between the outer tire and the inner tire in accordance with a second embodiment;

FIG. 12 is a sectional view, taken from the direction of arrows XII-XII in FIG. 11, of the rim spacer;

FIG. 13 is an enlarged sectional view illustrating the rim spacer and the like provided between the outer tire and the inner tire in accordance with a third embodiment;

FIG. 14 is a sectional view, taken from the direction of arrows XIV-XIV in FIG. 13, of the rim spacer;

FIG. 15 is a partially sectional view illustrating in an enlarged form the tire and the like on the rear wheel side in accordance with a fourth embodiment;

FIG. 16 is an enlarged sectional view of essential portions in FIG. 15 and illustrates the rim spacer and the like provided between the outer tire and the inner tire; and

FIG. 17 is a sectional view, taken from the direction of arrows XVII-XVII in FIG. 16, of the rim spacer.

### DETAILED DESCRIPTION OF THE PREFERRED EMBODIMENTS

Hereafter, referring to the accompanying drawings, a detailed description will be given by citing a case in which a transportation vehicle in accordance with an embodiment of the invention is applied to, for instance, a dump truck of a rear wheel drive dump truck.

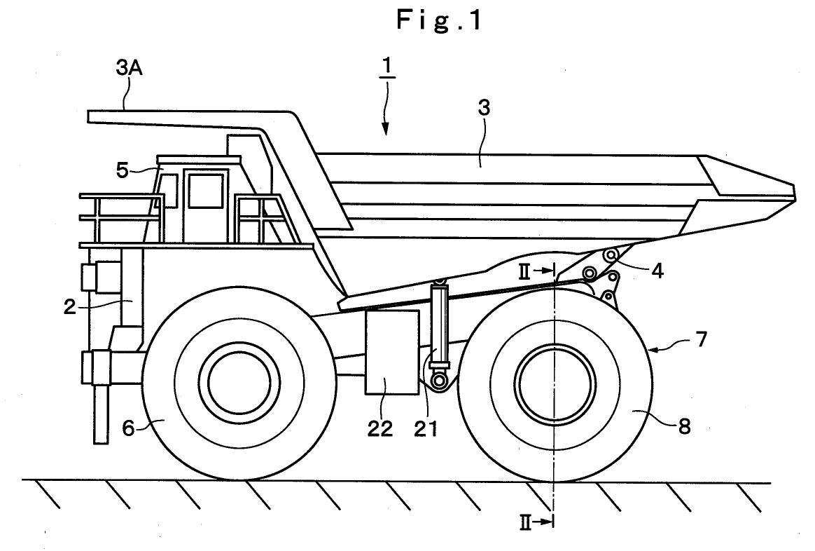

Referring to FIGS. 1 to 10, there is shown a first embodiment of the transportation vehicle in accordance with the present invention.

In the drawings, denoted at 1 is a dump truck as a transportation vehicle adopted in this embodiment. As shown in FIG. 1, the dump truck 1 is largely constituted by a vehicle body 2 forming a rigid frame structure and a vessel 3 serving as a loading platform which is liftably mounted on the vehicle body 2.

The vessel 3 is formed as a large-size container whose overall length reaches as much as 10 to 13 meters in order to load a heavy cargo such as crushed stones in a large quantity. Its rear side bottom portion is liftably (tiltably) connected to the rear end side of the vehicle body 2 by means of a pair of pin coupling portions 4 and the like. Further, a protector 3A which covers a below-described cabin 5 from the upper side is integrally provided at a front side upper portion of the vessel 3.

Indicated at 5 is a cabin which is built on a front potion of the vehicle body 2 so as to be positioned on the lower side of the protector 3A. The cabin 5 forms an operating room to be occupied by an operator of the dump truck 1, and internally equipped with an operator's seat, a starter switch, an accelerator pedal, a brake pedal, a steering handle, a plurality of operating levers (none of which are shown in the drawings), and the like.

Further, as the protector 3A of the vessel 3 is so arranged as to substantially completely cover the cabin 5 from the upper side to protect the latter from hard flying stones such as rocks and to protect the operator in the cabin 5 when the dump truck 1 is overturned.

Indicated at 6 are left and right front wheels (only the left one is shown in FIG. 1) which are provided rotatably on the front side of the vehicle body 2. The front wheels 6 constitute steering wheels which are steered by the operator of the dump truck 1. Similarly to rear wheels 7 which will be described hereafter, the front wheels 6 are formed with a tire diameter (outside diameter dimension) which reaches as much as 2 to 4 meters, for instance.

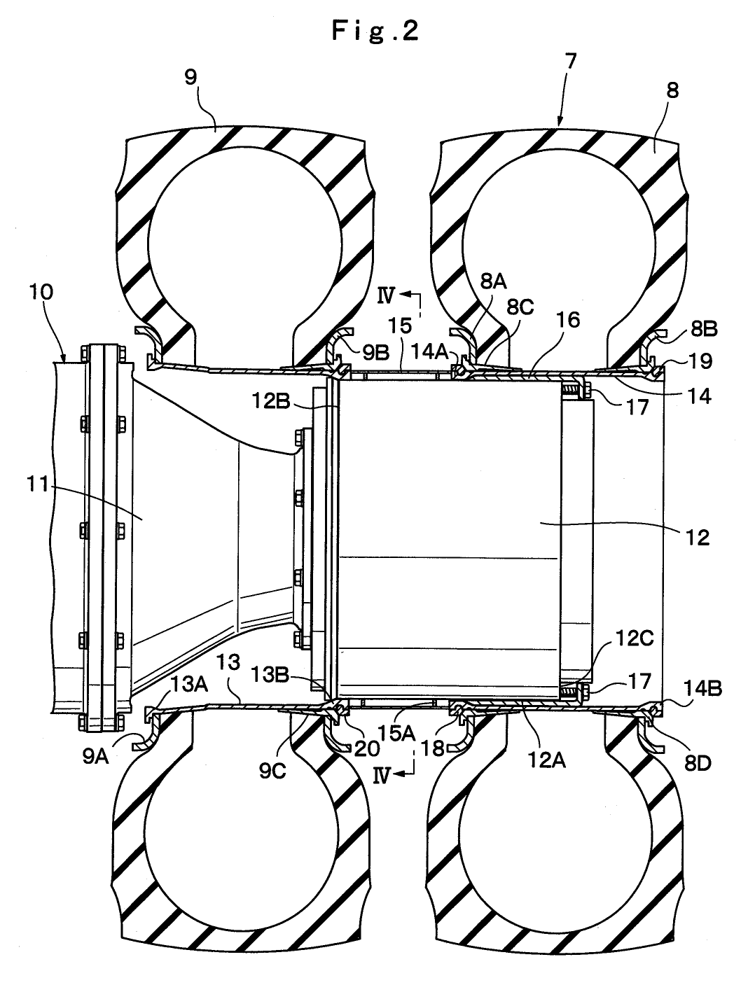

Indicated at 7 are left and right rear wheels (only the left one is shown in FIGS. 1 and 2) which are provided rotatably on the rear side of the vehicle body 2. The rear wheels 7 constitute drive wheels of the dump truck 1 which are rotatively driven integrally with below-described wheel mounting cylinders 12, as shown in FIG. 2. Further, the rear wheel 7 is constituted by including below-described multiple (e.g., dual) tires 8 and 9, an inner rim 13, an outer rim 14, a rim spacer 15, lock rings 18, 19, and 20, and the like.

Next, a description will be given of the multiple tires 8 and 9 constituting essential portions of the rear wheel 7. Namely, as shown in FIG. 2, denoted at 8 is a tire located on the outer side in the left-right direction (hereinafter referred to as the outer tire 8), and denoted at 9 is a tire located on the inner side of the outer tire 8 in the left-right direction (hereinafter referred to as the inner tire 9).

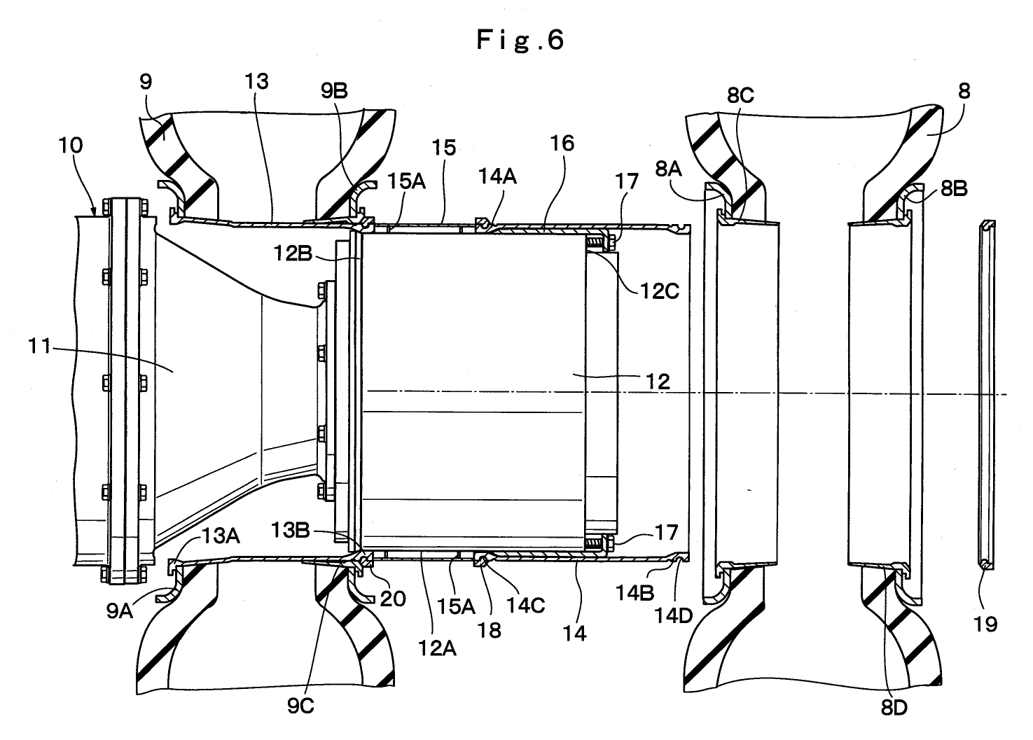

In this case, on the inside diameter side of the outer tire 8, a left-right pair of side rings 8A and 8B and a left-right pair of bead seat bands 8C and 8D, which are respectively secured to the inside diameter sides of the side rings 8A and 8B by using a fixing means such as fitting, press fitting, or welding, are provided in a preliminarily assembled (sub-assembled) state, as shown in FIG. 6. Besides, the bead seat bands 8C and 8D of the outer tire 8 constitute fitting rings which are slidably fitted on the outer peripheral surface side of the outer rim 14, which will be described later on.

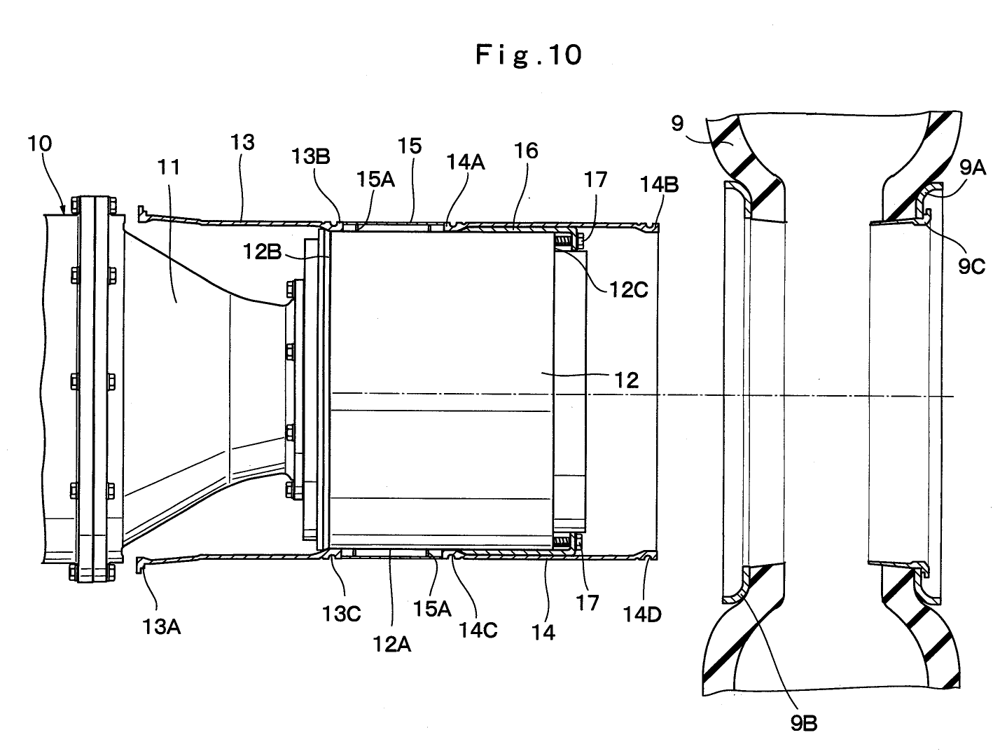

Meanwhile, as shown in FIG. 10, on the inside diameter side of the inner tire 9, a left-right pair of side rings 9A and 9B and a bead seat band 9C, which is secured to the inside diameter side of one side ring 9B between the side rings 9A and 9B by using a fixing means such as fitting, press fitting, or welding, are provided in a preliminarily assembled (sub-assembled) state. Further, in the case of the inner tire 9, the bead seat band 9C constitutes a fitting ring which is slidably fitted on the outer peripheral surface side of the inner rim 13, which will be described later on.

Next, designated at 10 is a traveling drive unit provided on the rear wheel 7 side of the dump truck 1. This traveling drive unit 10 is constituted by a below-described axle housing 11, the wheel mounting cylinder 12, an electric motor and a reduction gear mechanism (neither are shown), and the like. Further, the traveling drive unit 10 reduces the speed of the rotation of the electric motor by the reduction gear mechanism to drive traveling of the rear wheel 7 which is a drive wheel of the vehicle, together with the wheel mounting cylinder 12 with a large rotational torque.

Denoted at 11 is the axle housing for the rear wheel 7 provided on the lower side of a rear portion of the vehicle body 2. The axle housing 11 is formed as a tubular body extending in the axial direction between the left and right rear wheels 7 (in the left-right direction of the vehicle body 2). Further, the axle housing 11 is mounted to the lower side of the rear portion of the vehicle body 2 through a damper (not shown) such as a shock absorber.

In this instance, a pair of drive sources (e.g., large-output electric motors) for respectively rotatively driving the left and right rear wheels 7 separately are provided by being accommodated in the axle housing 11, and the output shafts (not shown) extends in the axial direction toward the interior of the below-described wheel mounting cylinder 12. The rotation of the output shaft is transmitted to the wheel mounting cylinder 12 as a low-speed, large torque.

Denoted at 12 is the wheel mounting cylinder which rotates integrally with the rear wheel 7 serving as a wheel. Each wheel mounting cylinder 12 is rotatably provided on the both axial end sides of the axle housing 11 through bearings (not shown) and the like. Further, the wheel mounting cylinder 12 constitutes a so-called wheel hub, and the inner rim 13, the outer rim 14, and the like of the rear wheel 7 together with clamps 16 are detachably mounted to its outer peripheral surface side by using a press-fitting and fitting means.

Here, the reduction gear mechanism (not shown) for reducing the rotation of the aforementioned output shaft is provided in the wheel mounting cylinder 12. This reduction gear mechanism generates a rotation which produces a large torque by reducing the speed of rotation of the aforementioned drive source (electric motor), and transmits this rotation to the wheel mounting cylinder 12 and, hence, to the rear wheel 7 (the outer tire 8 and the inner tire 9) serving as the drive wheel of the vehicle.

In addition, the outer peripheral surface of the wheel mounting cylinder 12 is formed as a tubular mounting surface 12A to which the below-described inner rim 13 and outer rim 14 are mounted by fitting. Further, an annular tapered surface portion 12B for holding the below-described inner rim 13 in a retained state is provided at an axially inner portion (left side in the left-right direction in FIG. 2) of the mounting surface 12A. Furthermore, a mounting end portion 12C where below-described bolts 17 are fitted is formed on the axially outer side (right side in the left-right direction in FIG. 2) of the wheel mounting cylinder 12.

Indicated at 13 is an inner rim which serves as a rim base for positioning the inner tire 9 on the outer peripheral surface side of the wheel mounting cylinder 12, and the inner rim 13 is constituted as a tire mounting rim of the so-called tapered type. In this instance, as shown in FIG. 10, the inner rim 13 is formed as a short-diameter tubular body extending in the axial direction, and a thick-walled retaining portion 13A serving as a back flange for holding the side ring 9B of the inner tire 9 in a retained state is integrally formed on its axially inner side. Further, the inside diameter of the inner rim 13 excluding a below-described abutment portion 13B is formed to be greater than the outside diameter of the wheel mounting cylinder 12.

In addition, the thick-walled abutment portion 13B serving as a gutter band for abutting against the tapered surface portion 12B of the wheel mounting cylinder 12 is integrally formed on the axially outer side of the inner rim 13. This abutment portion 13B is slidably fitted to an outer peripheral surface (mounting surface 12A) of the wheel mounting cylinder 12, and is formed with a predetermined smaller inside diameter dimension than the retaining portion 13A side. Further, as this abutment portion 13B abuts against the tapered surface portion 12B of the wheel mounting cylinder 12, the inner rim 13 is supported by the wheel mounting cylinder 12 in a cantilevered manner and is held in a retained state.

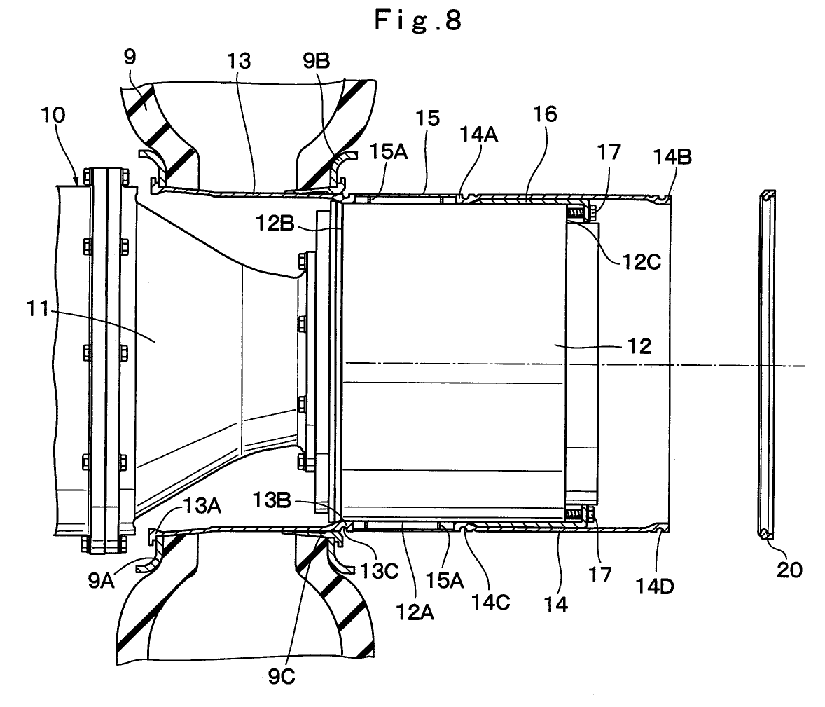

In the case, as shown in FIG. 8, the side ring 9A and the bead seat band 9C of the inner tire 9 are slidably fitted on the outer peripheral surface side of the inner rim 13, thereby allowing the inner tire 9 to be mounted on the outer peripheral surface side of the wheel mounting cylinder 12. In addition, an annular ring groove 13C is formed on the outer peripheral surface side of the abutment portion 13B of the inner rim 13, and a below-described lock ring 20 is detachably mounted in the ring groove 13C.

Designated at 14 is an outer rim which serves as a rim base for positioning the outer tire 8 on the outer peripheral surface side of the wheel mounting cylinder 12, and the outer rim 14 is constituted as a tire mounting rim of the so-called tapered type. In this instance, as shown in FIGS. 6 to 8, the outer rim 14 is formed as a short-diameter tubular body extending in the axial direction, and has a bilaterally symmetrical shape. Further, a thick-walled fringe portion 14A serving as a gutter band for slidably fitting to the outer peripheral surface (mounting surface 12A) of the wheel mounting cylinder 12 is integrally formed on the axially inner side of the outer rim 14.

Similarly, a thick-walled fringe portion 14B serving as another gutter band formed with an identical shape to that of the fringe portion 14A is integrally provided on the axially outer side of the outer rim 14. Then, the outer rim 14 is clamped from both axial sides thereof by using the below-described rim spacer 15 and clamps 16 in a state in which either one of the fringe portions 14A and 14B is selectively fitted to the outer peripheral surface (mounting surface 12A) of the wheel mounting cylinder 12, thereby allowing the outer rim 14 to be fixed to the outer peripheral surface side of the wheel mounting cylinder 12 in a retained state.

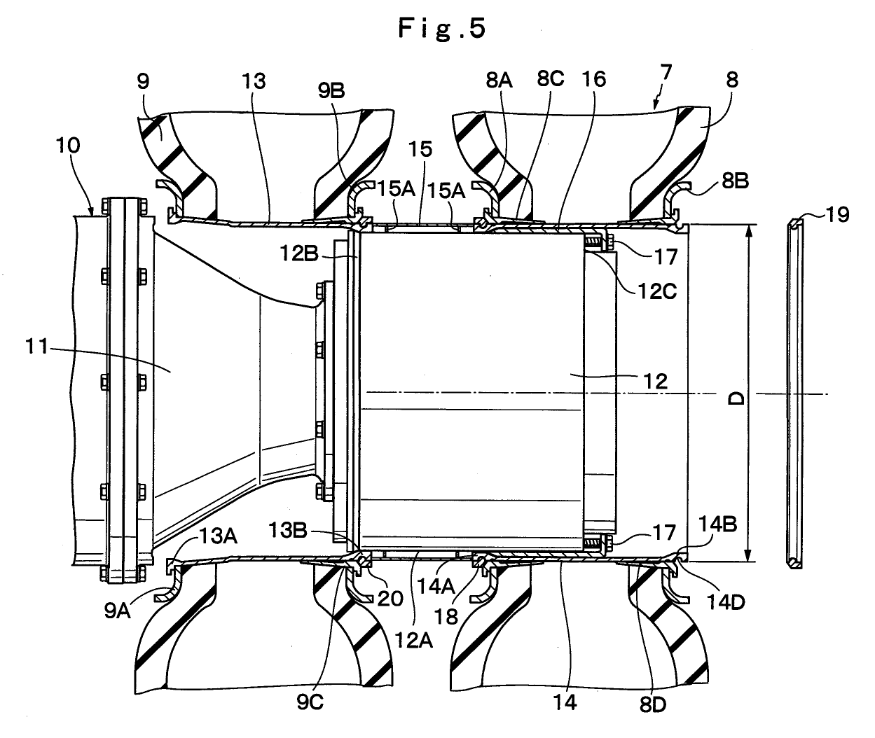

In this case, as shown in FIG. 5, the bead seat bands 8C and 8D of the outer tire 8 are slidably fitted on the outer peripheral surface side of the outer rim 14, thereby allowing the outer tire 8 to be fitted on the outer peripheral surface side of the wheel mounting cylinder 12. In addition, annular ring grooves 14C and 14D are respectively formed on outer peripheral surface sides of the fringe portions 14A and 14B of the outer rim 14, and the below-described lock rings 18 and 19 are detachably mounted in these ring grooves 14C and 14D.

Indicated at 15 is a rim spacer, and the rim spacer 15 constitutes a part of the rear wheel 7 together with the inner rim 13 and the outer rim 14. The rim spacer 15 is disposed between the inner rim 13 and the outer rim 14 on the outer peripheral surface side of the wheel mounting cylinder 12 to thereby secure a clearance in the left-right direction (axial direction) between the outer tire 8 and the inner tire 9.

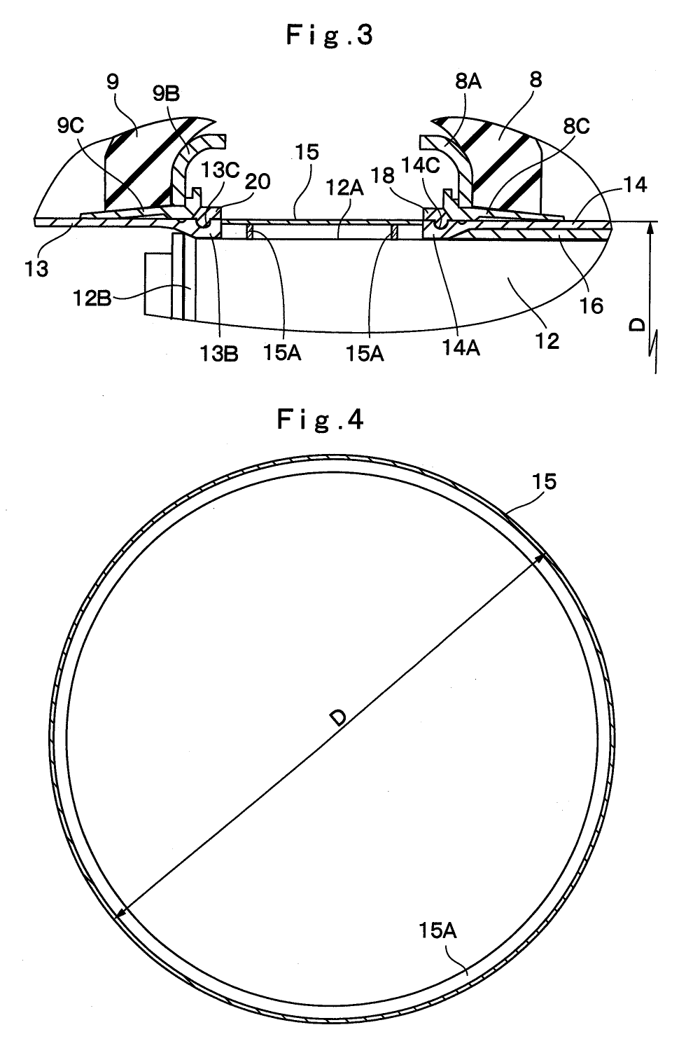

Here, as shown in FIGS. 3 and 4, the rim spacer 15 is formed as a short-diameter tubular ring, and, for example, two inner rings 15A are provided on its inner peripheral side in such a manner as to be axially spaced apart from each other. Further, the rim spacer 15 is fitted to the outer peripheral surface (mounting surface 12A) of the wheel mounting cylinder 12 through the inner rings 15A, and is clamped between the inner rim 13 and the outer rim 14 from both axial sides.

In addition, as shown in FIGS. 3 to 5, the outside diameter D of the rim spacer 15 is formed with an equal outside diameter (equivalent outside diameter dimension) to those of the fringe portions 14A and 14B of the outer rim 14, thereby providing an arrangement for eliminating a step (a dimensional difference in the radial direction) between the fringe portion 14A of the outer rim 14 and the rim spacer 15. Meanwhile, as for the abutment portion 13B of the inner rim 13 as well, its outside diameter is formed with an equivalent dimension (equal dimension) to the outside diameter D of the rim spacer 15, thereby providing an arrangement for eliminating a step (a dimensional difference in the radial direction) therebetween. Accordingly, the rim spacer 15 is held with an equivalent outside diameter dimension to those of the abutment portion 13B of the inner rim 13 and the fringe portions 14A and 14B of the outer rim 14 by the aforementioned inner rings 15A.

Denoted at 16 are the clamps for fixing the rear wheel 7 to the outer peripheral surface side of the wheel mounting cylinder 12. These clamps 16 are constituted by more than 10 members arranged at intervals in the circumferential direction of the wheel mounting cylinder 12, and fix the inner rim 13 and the outer rim 14 together with the rim spacer 15 to the wheel mounting cylinder 12 in a retained and non-rotatable state. Namely, the clamps 16 consist of a plurality of wedge-shaped members which function as so-called “wedges,” and are fitted between the mounting surface 12A of the wheel mounting cylinder 12 and the inner peripheral surface of the outer rim 14 by using a press-fitting means.

Further, the clamps 16 are respectively fixed to the mounting end portion 12C of the wheel mounting cylinder 12 in a tightening manner by the bolts 17 whose number reaches as many as 20 and more in a state in which axial one sides of the clamps 16 are press-fitted between the mounting surface 12A of the wheel mounting cylinder 12 and the inner peripheral surface of the outer rim 14. Consequently, the clamps 16 clamp the fringe portion 14A of the outer rim 14 between the same and the rim spacer 15 from the axial direction so as to fix the outer rim 14 to the outer peripheral surface side of the wheel mounting cylinder 12 in the retained state. At this time, the inner rim 13 is also fixed (clamped) in the retained state by means of the rim spacer 15 and the tapered surface portion 12B of the wheel mounting cylinder 12.

Indicated at 18 and 19 are the lock rings for retaining the outer tire 8 of the rear wheel 7 to the outer rim 14. These lock rings 18 and 19 are constituted by using, for example, half rings which are divided in two, and are detachably mounted in the ring grooves 14C and 14D of the outer rim 14 from the radially outer side.

Namely, as shown in FIG. 3, the lock ring 18 is mounted in the ring groove 14C of the outer rim 14 from the radially outer side, and in this state opposite end sides of the aforementioned half rings are fixed by using coupling means or the like. Further, as shown in FIG. 3, in this state the lock ring 18 abuts against an end portion of the bead seat band 8C with an interference, and effects the retaining of the outer tire 8 by means of this bead seat band 8C and the side ring 8A.

Similarly, the lock ring 19 is mounted in the ring groove 14D of the outer rim 14 by using coupling means or the like. Further, as shown in FIG. 2, the lock ring 19 abuts against an end portion of the bead seat band 8D with an interference, and effects the retaining of the outer tire 8 by means of the bead seat band 8D and the side ring 8B.

Designated at 20 is the lock ring for retaining the inner tire 9 to the inner rim 13. The lock ring 20 is constituted by using half rings in the same way as the aforementioned outer side lock rings 18 and 19. In this instance, the lock ring 20 is mounted in the ring groove 13C of the inner rim 13 from the radially outer side, and is fixed in this state by using the coupling means or the like. Further, as shown in FIG. 3, this lock ring 20 abuts against an end portion of the bead seat band 9C with an interference, and effects the retaining of the inner tire 9 by means of this bead seat band 9C and the side ring 9B.

In addition, denoted at 21 is a pair of hoist cylinders for lifting up the vessel 3 of the dump truck 1 shown in FIG. 1. The pair of hoist cylinders 21 are respectively disposed on both left and right sides of the vehicle body 2 in such a manner as to be positioned between the front wheels 6 and the rear wheels 7, as shown in FIG. 1. As pressure oil is supplied to the hoist cylinders 21 from the outside or discharged therefrom, the hoist cylinders 21 are extended or contracted vertically to lift up (tilt) the vessel 3 about the pin coupling portions 4 on the rear side.

Denoted at 22 is an operating oil tank, and the operating oil tank 22 is mounted on a side surface or the like of the vehicle body 2 at a position below the vessel 3, as shown in FIG. 1. Further, the operating oil accommodated in the operating oil tank 22 is converted into pressure oil by a hydraulic pump and is supplied to or discharged from the hoist cylinders 21, a steering cylinder for power steering, and the like.

The dump truck 1 in accordance with the first embodiment has the above-described construction, and a description will be given of its operation.

First, when the operator who has got into the cabin 5 of the dump truck 1 starts the engine (not shown), i.e., a prime mover, the hydraulic pump (not shown) serving as a hydraulic power source is rotatively driven, and electrical power is generated by an alternator and the like. While a battery and the like are being charged by this electrical power, the electrical power is fed to an electrical controller and the like (not shown).

Then, when the vehicle is driven for traveling, a drive current is fed to left and right electric motors on the rear wheels 7 side from the aforementioned electrical controller. At this time, the electrical controller individually feedback-controls the numbers of revolution of the left and right electric motors. In consequence, the left and right rear wheels 7 serving as the drive wheels of the vehicle are rotatively driven independently of each other, and are driven with mutually identical numbers of revolution during straight traveling.

Namely, the traveling drive unit 10 provided on the rear wheel 7 side of the dump truck 1 reduces the speed of rotation of the electric motor with a large reduction ratio by the reduction gear mechanism, and drives the rear wheel 7 to travel with a large rotational torque together with the wheel mounting cylinder 12. In this case, the left and right rear wheels 7 are driven with numbers of revolution which are mutually independent by the left and right electric motors.

Incidentally, multiple tires, each set consisting of the outer tire 8 and the inner tire 9, are used on the rear wheel 7 side of the dump truck 1. In consequence, the superimposed load ratio per tire 8, 9 is reduced, so that it becomes possible to increase the weight of the cargo to be loaded on the vessel 3.

However, the outside diameter dimension of each of the tires 8 and 9 is formed with a diameter as large as 2 to 4 meters, for example, and its weight is as large as 1 to 3 tons. For this reason, the operations of drawing out the multiple tires (the outer tire 8 and the inner tire 9) in such a manner as to pull them out from the wheel mounting cylinder 12 and of conversely remounting the tires to the wheel mounting cylinder 12 at the time of periodic inspection require much time and trouble, so that the operational efficiency at the time of maintenance is poor.

Namely, in terms of the general procedure of dismounting the outer tire 8 and the inner tire 9 of the multiple tire type from the wheel mounting cylinder 12, the plurality of bolts 17 shown in FIG. 2 are first removed, and the clamps 16 consisting of more than 10 members are drawn out in such a manner as to be pulled out from the outer peripheral surface side of the wheel mounting cylinder 12. Next, the outer tire 8 together with the outer rim 14 is removed from the outer peripheral surface side of the wheel mounting cylinder 12. Subsequently, the rim spacer 15 is removed in such a manner as to be drawn out from the outer peripheral surface side of the wheel mounting cylinder 12, and the inner tire 9 together with the inner rim 13 is finally removed from the outer peripheral surface side of the wheel mounting cylinder 12.

In this case, however, the operation of removing the plurality of bolts 17 requires time and trouble, and large effort and time are also expended in the operation of drawing out the plurality of clamps 16 in such a manner as to pull them out from the outer peripheral surface side of the wheel mounting cylinder 12. Moreover, if there are variations in the tightening torque and the like of the plurality of bolts 17 in the state in which the outer tire 8 and the inner tire 9 of the multiple tire are remounted to the wheel mounting cylinder 12 in the end of the maintenance operation, for example, the bolts 17 can become loose, possibly resulting in the falling off of the tire.

For this reason, the present inventors studied the carrying out of maintenance and replacement operation of the outer tire 8 and the inner tire 9 without removing the bolts 17 and the clamps 16 in the above-described manner, in a state in which the inner rim 13 and the outer rim 14 are remained mounted on the outer peripheral surface side of the wheel mounting cylinder 12.

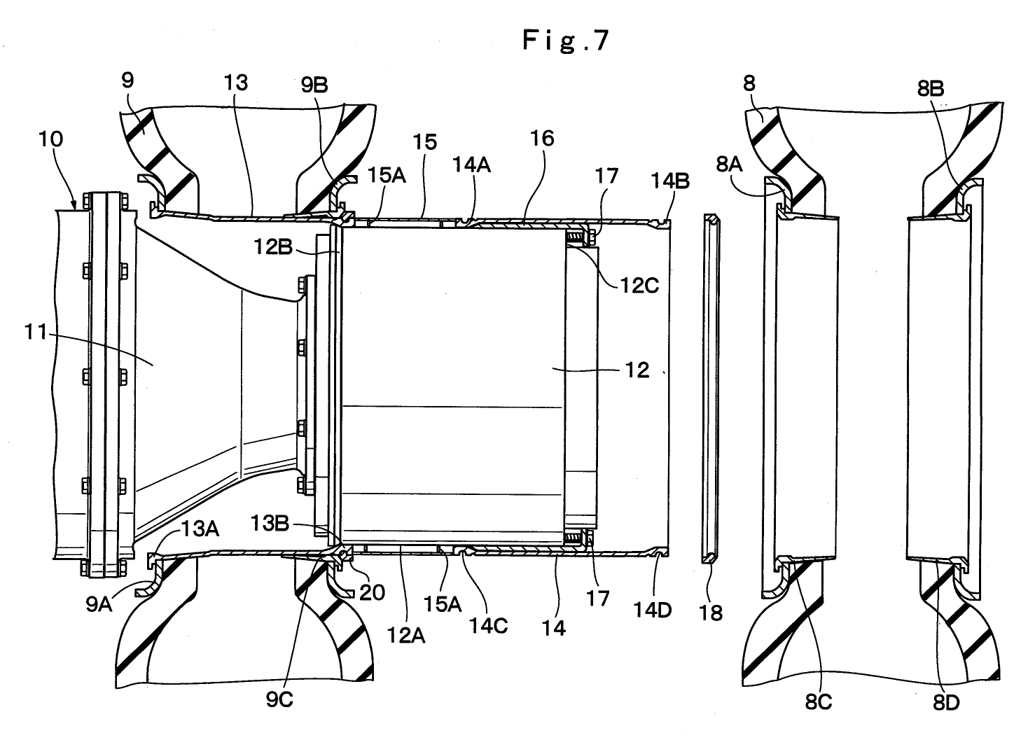

Namely, in the case of the first embodiment, the retention of the bead seat band 8D of the outer tire 8 by the lock ring 19 is canceled by removing the lock ring 19 in such a manner as to snap it off the ring groove 14D of the outer rim 14, as shown in FIG. 5. In this state, the outer tire 8 together with the side rings 8A and 8B and the bead seat bands 8C and 8D is drawn out in such a manner as to be pulled out from the outer peripheral surface side of the outer rim 14, as shown in FIG. 6. Then, as shown in FIG. 7, the lock ring 18 is removed in such a manner as to be drawn out after being disengaged from the ring groove 14C of the outer rim 14.

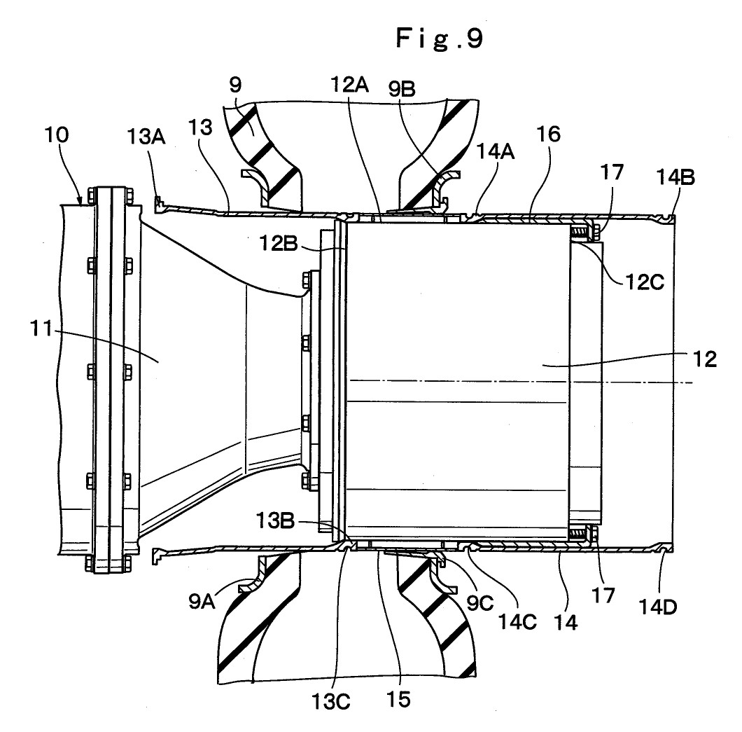

Upon completion of the drawing-out operation of the outer tire 8, the removing operation of the inner tire 9 is then carried out. In this case, as shown in FIG. 8, the lock ring 20 is removed in such a manner as to be drawn out after being disengaged from the ring groove 13C of the inner rim 13. Subsequently, the inner tire 9 together with the bead seat band 9C and the side rings 9A and 9B is pulled out in the axial direction from the outer peripheral surface side of the inner rim 13 toward the outer peripheral surface side of the rim spacer 15 (see FIG. 9).

However, at this time, if there is a step between the outer peripheral surface of the inner rim 13 and the outer peripheral surface of the rim spacer 15, the inner tire 9, which is a heavy piece, is unfavorably inclined diagonally between the inner rim 13 and the rim spacer 15 owing to the step. Hence, extra time and trouble are required to pull out the inner tire 9 (including the bead seat band 9C and the side rings 9A and 9B) in the axial direction from the outer peripheral surface side of the inner rim 13.

In addition, if there is a step between the outer peripheral surface of the rim spacer 15 and the outer peripheral surface of the outer rim 14, there is a possibility of the inner tire 9 (particularly the bead seat band 9C) may become caught by the aforementioned step between the outer rim 14 and the rim spacer 15. Accordingly, in order to pull out the inner tire 9 axially toward the outer peripheral surface sides of the rim spacer 15 and the outer rim 14 from the state shown in FIG. 9, it is necessary to keep the inner tire 9 horizontal while lifting the inner tire 9, which is a heavy piece, by using, for instance, a hydraulic crane or the like.

In order to overcome this problem, in the first embodiment, the outside diameter D of the rim spacer 15 is formed with an equal outside diameter dimension to those of the fringe portions 14A and 14B of the outer rim 14, as shown in FIGS. 3 to 5, thereby providing an arrangement for eliminating a step between the fringe portion 14A of the outer rim 14 and the rim spacer 15. Meanwhile, as for the abutment portion 13B of the inner rim 13 as well, its outside diameter is formed with an equivalent dimension to the outside diameter D of the rim spacer 15, thereby providing an arrangement for eliminating a step therebetween.

In consequence, in the first embodiment, it is possible to prevent the inner tire 9 from becoming inclined diagonally between the inner rim 13 and the rim spacer 15, and to prevent the inner tire 9 (particularly the bead seat band 9C) from becoming caught between the outer rim 14 and the rim spacer 15.

Therefore, according to the first embodiment, at the time of dismounting the outer tire 8 and the inner tire 9 of the multiple tire type from the wheel mounting cylinder 12, in the state in which the inner rim 13, the outer rim 14, and the rim spacer 15 are kept fixed to the wheel mounting cylinder 12, the outer tire 8 and the inner tire 9 of the multiple tire type can be smoothly pulled out and removed along their outer peripheral surfaces without being hampered by a step.

As a result, the operations of mounting and dismounting the multiple tires 8 and 9 with respect to the wheel mounting cylinder 12 can be performed easily, thereby making it possible to substantially improve the operational efficiency at the time of assembly and maintenance and substantially alleviate such as the burden on the operator.

In addition, the construction provided is such that the bead seat bands 8C and 8D serving as fitting rings are provided on the inside diameter side of the outer tire 8, and the lock rings 18 and 19 are detachably provided on the outer peripheral surface side of the outer rim 14 through the ring grooves 14C and 14D. Meanwhile, the bead seat band 9C serving as a fitting ring is provided on the inside diameter side of the inner tire 9, and the lock ring 20 is detachably provided on the outer peripheral surface side of the inner rim 13 through the ring groove 13C.

As such, when the outer tire 8 and the inner tire 9 are drawn out from the wheel mounting cylinder 12, the lock ring 19 is first removed from the ring groove 14D of the outer rim 14. Hence, the outer tire 8 together with the bead seat bands 8C and 8D can be drawn out in such a manner as to be pulled out along the outer peripheral surface of the outer rim 14. Subsequently, as the lock ring 18 is removed from the ring groove 14C of the outer rim 14, and the lock ring 20 is removed from the ring groove 13C of the inner rim 13, the inner tire 9 together with the bead seat band 9C can be drawn out in such a manner as to be pulled out along the outer peripheral surface of the inner rim 13.

On the other hand, when, conversely, the inner tire 9 and the outer tire 8 are mounted by fitting in such a manner as to be slid along the outer peripheral surfaces of the inner rim 13 and the outer rim 14, the lock rings 18, 19, and 20 are mounted to the outer peripheral surface sides of the inner rim 13 and the outer rim 14 through the ring grooves 13C, 13D, and 14C. Consequently, the lock rings 18, 19, and 20 can be abutted against the bead seat bands 8C, 8D, and 9C with interferences, thereby making it possible to reliably perform the retention of the inner tire 9 and the outer tire 8.

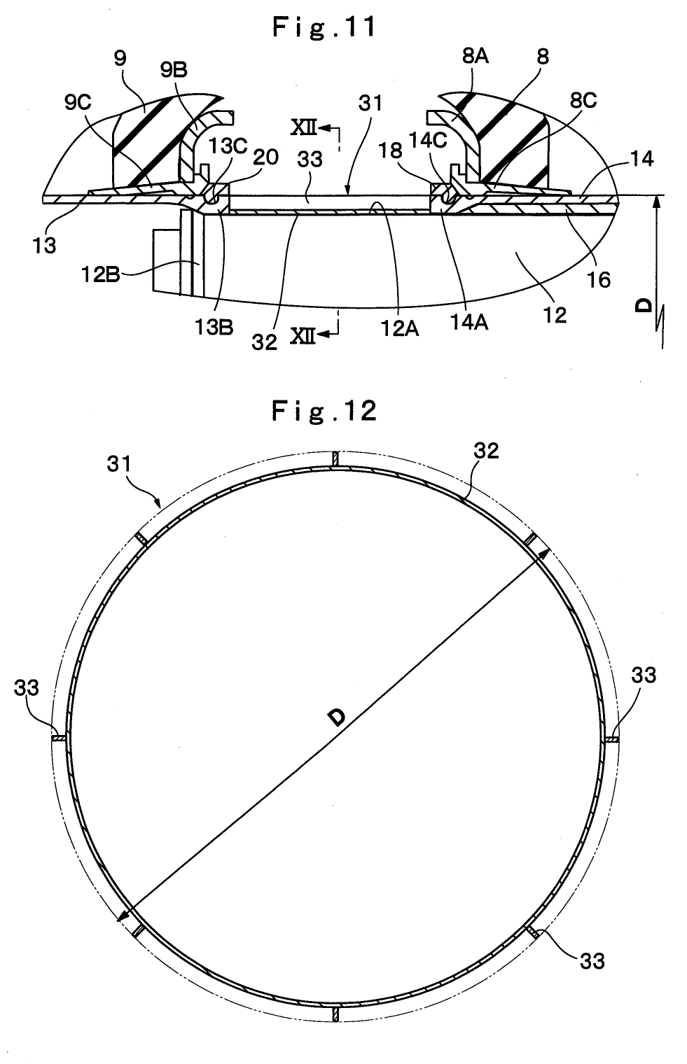

Next, FIGS. 11 and 12 show a second embodiment of the present invention. In the following description of the second embodiment, the component elements identical to those of the foregoing first embodiment will be simply denoted by the same reference numerals to avoid repetitions of similar explanations.

However, the characteristic feature of the second embodiment lies in that a rim spacer 31 for securing a clearance in the left-right direction (axial direction) between the outer tire 8 and the inner tire 9 is constituted by a short-diameter tubular ring 32 and a plurality of rail members 33 provided on the outer peripheral surface side of the tubular ring 32.

In this instance, the rim spacer 31 is constructed substantially in the same way as the rim spacer 15 described in the above-described first embodiment, and is disposed between the inner rim 13 and the outer rim 14 on the outer peripheral surface side of the wheel mounting cylinder 12, as shown in FIG. 11. Further, the tubular ring 32 and the rail members 33 of the rim spacer 31 are clamped from both axial sides between the inner rim 13 and the outer rim 14 to thereby secure a clearance in the left-right direction between the outer tire 8 and the inner tire 9.

However, as for the rim spacer 31 in this case, the tubular ring 32 is formed with an inside diameter dimension substantially equal to the diameter of the outer peripheral surface (mounting surface 12A) of the wheel mounting cylinder 12, and is fitted to the outer periphery of the wheel mounting cylinder 12 almost without a clearance. In addition, as shown in FIG. 12, the rail members 33 of the rim spacer 31 are provided in such a manner as to project radially outward from the outer periphery of the tubular ring 32, and are arranged at intervals in the circumferential direction of the tubular ring 32, extending in the axial direction thereof.

In addition, as shown in FIG. 12, these rail members 33 define the outside diameter D of the rim spacer 31, and its outside diameter D is formed with an equal outside diameter (equivalent outside diameter dimension) to those of the fringe portions 14A and 14B of the outer rim 14. Further, as for the abutment portion 13B of the inner rim 13 as well, its outside diameter is formed with an equivalent dimension (equal dimension) to the outside diameter D of the rim spacer 31, thereby providing an arrangement for eliminating a step therebetween.

Thus, also in the second embodiment constructed, as the outside diameter D of the rim spacer 31 is formed with an equal outside diameter (equivalent outside diameter dimension) to those of the abutment portion 13B of the inner rim 13 and the fringe portions 14A and 14B of the outer rim 14, it is possible to obtain operational effects substantially similar to those of the above-described first embodiment.

Further, in the second embodiment, when the inner tire 9 is dismounted from the wheel mounting cylinder 12 along the outer periphery of the rim spacer 31 or is mounted to the wheel mounting cylinder 12, the rail members 33 can be made to function as guide rails for the inner tire 9, thereby making it possible to prevent a step from being produced between, for instance, the fringe portion 14A of the outer rim 14 and the rim spacer 31. In addition, it is also possible to prevent a step from being produced between the abutment portion 13B of the inner rim 13 and the rim spacer 31.

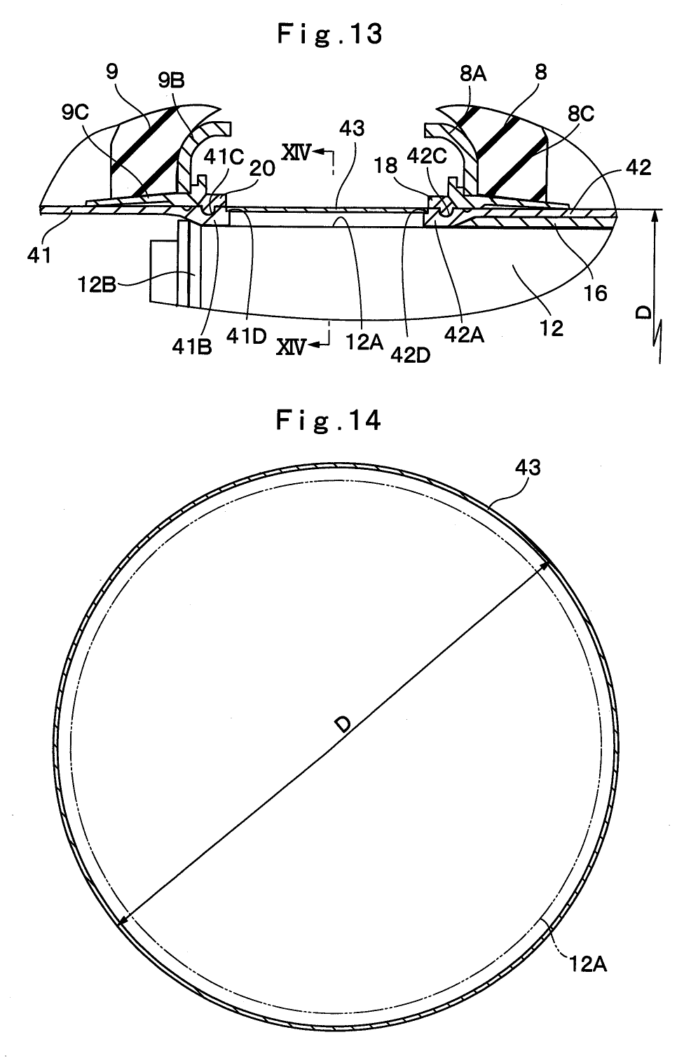

Next, FIGS. 13 and 14 show a third embodiment of the present invention. The characteristic feature of the third embodiment lies in an arrangement in which the rim spacer is provided in the form of bridging the inner rim and the outer rim. It should be noted that, in the following description of the third embodiment, the component elements identical to those of the foregoing first embodiment will be simply denoted by the same reference numerals to avoid repetitions of similar explanations.

In the drawings, denoted at 41 is an inner rim serving as a rim base adopted in the third embodiment, and the inner rim 41 is constructed substantially in the same way as the inner rim 13 described in the first embodiment. Further, a thick-walled retaining portion (not shown) serving as a back flange for holding the side ring 9A of the inner tire 9 in a retained state is formed on the axially inner side (left side in the left-right direction) of the inner rim 41 in the same way as the retaining portion 13A shown in FIG. 2.

In addition, a thick-walled abutment portion 41B serving as a gutter band is integrally formed on the axially outer side (right side in the left-right direction) of the inner rim 41. As this abutment portion 41B abuts against the tapered surface portion 12B of the wheel mounting cylinder 12, the inner rim 41 is supported by the wheel mounting cylinder 12 in a cantilevered manner and is held in a retained state. In addition, an annular ring groove 41C is formed on the outer peripheral surface side of the abutment portion 41B of the inner rim 41, and the lock ring 20 is detachably mounted in the ring groove 41C.

However, the abutment portion 41B of the inner rim 41 adopted in the third embodiment differs from the abutment portion 13B of the first embodiment in that an annular notch 41D is formed on its outer peripheral surface side (radially outer side), one side end portion of a below-described rim spacer 43 being fitted to the notch 41D. The arrangement provided is such that, in the state in which the end portion of the rim spacer 43 is fitted to the notch 41D, a step is not produced between the abutment portion 41B of the inner rim 41 and the rim spacer 43.

Indicated at 42 is an outer rim serving as a rim base for positioning the outer tire 8 on the outer peripheral surface side of the wheel mounting cylinder 12, and the outer rim 42 is constituted in the same way as the outer rim 14 described in the first embodiment. Further, a pair of thick-walled fringe portions 42A (only one is shown), serving as gutter bands, are formed integrally on both axial sides thereof. In addition, an annular ring groove 42C is formed on the outer peripheral surface side of each fringe portion 42A of the outer rim 42, and the lock ring 18 is detachably mounted in the ring groove 42C.

However, the fringe portion 42A of the outer rim 42 adopted in the third embodiment differs from the fringe portion 14A of the first embodiment in that an annular notch 42D is formed on its outer peripheral surface side (radially outer side), the other end portion of the below-described rim spacer 43 being fitted to the notch 42D. The arrangement provided is such that, in the state in which the end portion of the rim spacer 43 is fitted to the notch 42D, a step is not produced between the fringe portion 42A of the outer rim 42 and the rim spacer 43.

Indicated at 43 is a rim spacer which constitutes a part of the rear wheel 7 together with the inner rim 41 and the outer rim 42. This rim spacer 43 is constructed substantially in the same way as the rim spacer 15 described in the first embodiment. Further, the rim spacer 43 is disposed between the inner rim 41 and the outer rim 42 on the outer peripheral surface side of the wheel mounting cylinder 12 to secure a clearance in the left-right direction (axial direction) between the outer tire 8 and the inner tire 9.

However, as shown in FIG. 14, the rim spacer 43 is formed as a short-diameter tubular ring, and its both axial sides are fitted to the notch 41D of the inner rim 41 and the notch 42D of the outer rim 42 respectively. In consequence, the rim spacer 43 is provided in such a manner as to bridge the inner rim 41 and the outer rim 42, and is clamped from both axial sides between the abutment portion 41B of the inner rim 41 and the fringe portion 42A of the outer rim 42.

Further, as shown in FIG. 13, the rim spacer 43 is formed with an equal outside diameter (equivalent outside diameter dimension) to that of the fringe portion 42A of the outer rim 42. As for the abutment portion 41B of the inner rim 41 as well, its outside diameter is formed with an equivalent dimension to the outside diameter D of the rim spacer 43. An arrangement is thereby provided for the rim spacer 43 so as to prevent a step from being produced between the abutment portion 41B of the inner rim 41 and the fringe portion 42A of the outer rim 42.

As such, also in the third embodiment thus constructed, as the outside diameter D of the rim spacer 43 is formed with an equal outside diameter to those of the abutment portion 41B of the inner rim 41 and the fringe portions 42A of the outer rim 42, it is possible to obtain operational effects substantially similar to those of the above-described first embodiment.

Further, in the third embodiment, when the inner tire 9 is dismounted from the wheel mounting cylinder 12 along the outer periphery of the rim spacer 43 or is mounted to the wheel mounting cylinder 12, the outer peripheral surface of the rim spacer 43 can be made to function as a guide surface, thereby making it possible to prevent a step from being produced between the fringe portion 42A of the outer rim 42 and the rim spacer 43. In addition, it is also possible to prevent a step from being produced between the abutment portion 41B of the inner rim 41 and the rim spacer 43.

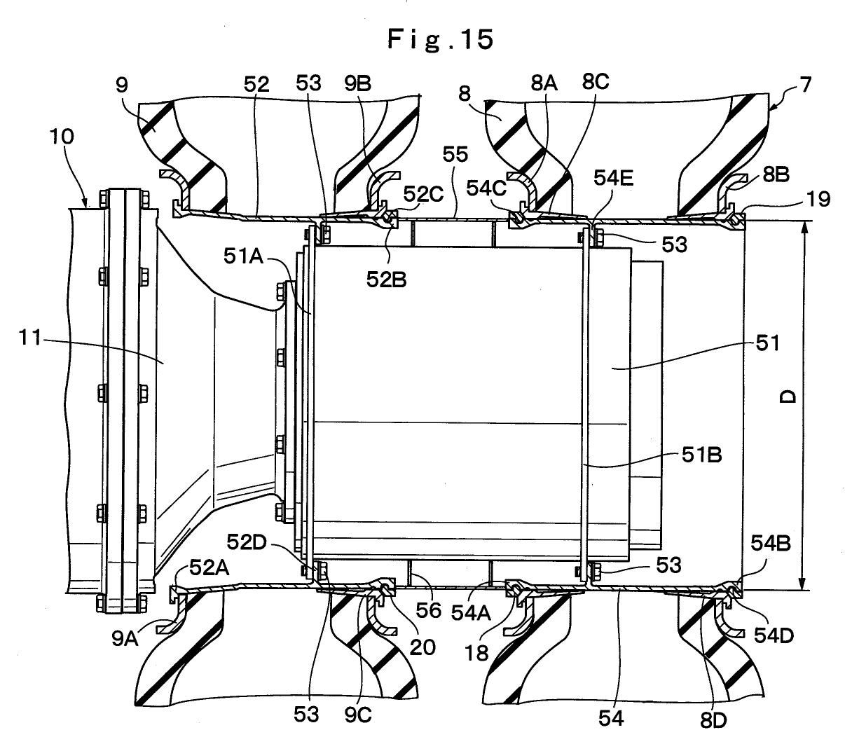

Next, FIGS. 15 to 17 show a fourth embodiment of the present invention. The characteristic feature of the fourth embodiment lies in that the invention is applied to tire mounting rims of the so-called center disk type. It should be noted that, in the following description of the fourth embodiment, the component elements identical to those of the foregoing first embodiment will be simply denoted by the same reference numerals to avoid repetitions of similar explanations.

In the drawings, denoted at 51 is a wheel mounting cylinder adopted in the fourth embodiment. The wheel mounting cylinder 51 is constructed substantially in the same way as the wheel mounting cylinder 12 described in the first embodiment, and is rotatably provided on the respective axial end sides of the axle housing 11 through bearings (not shown) and the like. However, as for the wheel mounting cylinder 51 in this case, two annular projections 51A and 51B are integrally provided on its outer peripheral side in an axially spaced apart from each other.

In this instance, the annular projections 51A and 51B of the wheel mounting cylinder 51 are respectively provided with, for example, 20 to 30 bolt mounting holes (not shown) at intervals in the circumferential direction. An inner rim 52 and an outer rim 54 of the rear wheel 7 are detachably mounted to the outer peripheral side of the wheel mounting cylinder 51 by fastening below-described bolts 53 in the bolt mounting holes.

Here, designated at 52 is an inner rim serving as a rim base for positioning the inner tire 9 on the outer peripheral side of the wheel mounting cylinder 51. The inner rim 52 is constructed substantially in the same way as the inner rim 13 described in the first embodiment, and includes a thick-walled retaining portion 52A serving as a back flange, a thick-walled portion 52B serving as a gutter band, an annular ring groove 52C, and the like. However, the inner rim 52 differs from the inner rim 13 of the first embodiment in that it is constituted as a tire mounting rim of the so-called center disk type.

For this reason, an annular disk 52D is integrally formed on the inner peripheral side of the inner rim 52, and the disk 52D is provided with, for example, 20 to 30 bolt through holes (not shown) at intervals in the circumferential direction in correspondence with the bolt mounting holes of the annular projection 51A of the wheel mounting cylinder 51. The inner rim 52 is fixed to the outer peripheral side of the wheel mounting cylinder 51 by fastening the disk 52D to the annular projection 51A of the wheel mounting cylinder 51 by means of the plurality of bolts 53.

Indicated at 54 is an outer rim serving as a rim base for positioning the outer tire 8 on the outer peripheral side of the wheel mounting cylinder 51. The outer rim 54 is constructed substantially in the same way as the outer rim 14 described in the first embodiment, and includes thick-walled fringe portions 54A and 54B serving as gutter bands, annular ring grooves 54C and 54D, and the like. However, the outer rim 54 differs from the outer rim 14 of the first embodiment in that it is constituted as a tire mounting rim of the so-called center disk type.

For this reason, an annular disk 54E is integrally formed on the inner peripheral side of the outer rim 54, and the disk 54E is provided with, for example, 20 to 30 bolt through holes (not shown) at intervals in the circumferential direction in correspondence with the bolt mounting holes of the annular projection 51B of the wheel mounting cylinder 51. The outer rim 54 is fixed to the outer peripheral side of the wheel mounting cylinder 51 by fastening the disk 54E to the annular projection 51B of the wheel mounting cylinder 51 by means of the plurality of bolts 53.

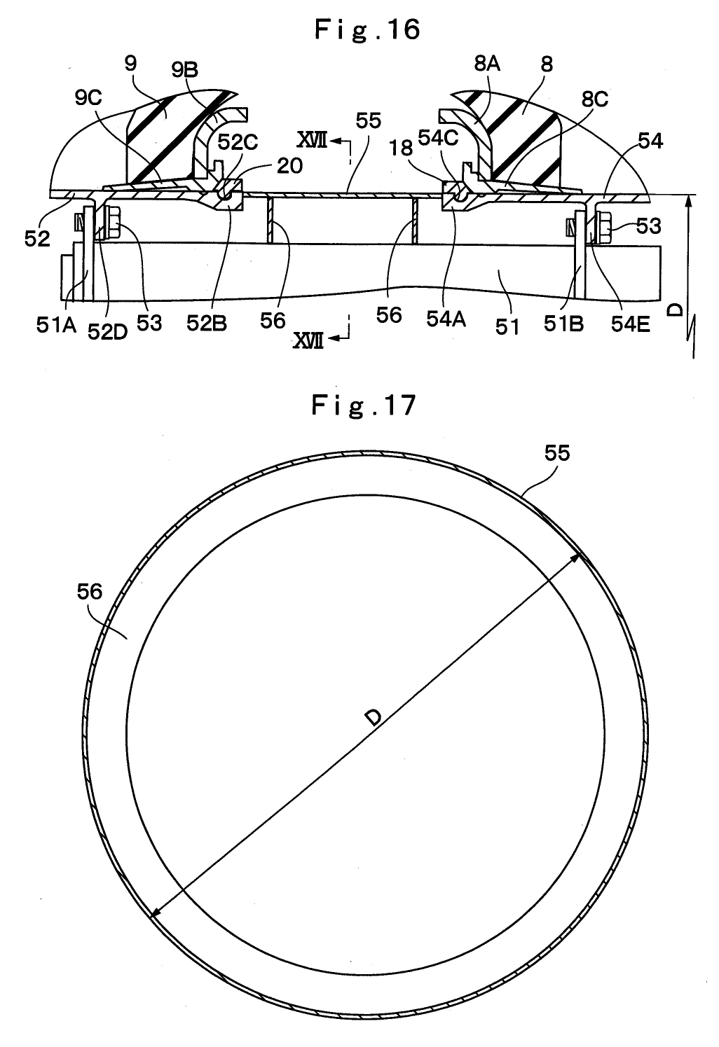

Denoted at 55 is a rim spacer 43 which constitutes a part of the rear wheel 7 together with the inner rim 52 and the outer rim 54. This rim spacer 55 is constructed substantially in the same way as the rim spacer 15 described in the first embodiment, and is formed as a short-diameter tubular ring, as shown in FIGS. 15 and 16. In addition, for example, two inner rings 56 are provided on the inner peripheral side of the rim spacer 55 in such a manner as to be axially spaced apart from each other.

Further, the rim spacer 55 is fitted to the outer peripheral surface of the wheel mounting cylinder 51 through the inner rings 56, and is disposed so as to be clamped between the inner rim 52 and the outer rim 54 from both axial sides on the outer peripheral side of the wheel mounting cylinder 51. In addition, as shown in FIGS. 15 to 17, the outside diameter D of the rim spacer 55 is formed with an equal outside diameter to those of the fringe portions 54A and 54B of the outer rim 54. Meanwhile, as for the thick-walled portion 52B of the inner rim 52 as well, its outside diameter is formed with an equivalent dimension to the outside diameter D of the rim spacer 55.

As such, also in the fourth embodiment thus constructed, as the outside diameter D of the rim spacer 55 is formed with an equal outside diameter to those of the thick-walled portion 52B of the inner rim 52 and the fringe portions 54A and 54B of the outer rim 54, it is possible to obtain operational effects substantially similar to those of the above-described first embodiment even in the case where the invention is applied to the tire mounting rims of the so-called center disk type.

Further, in the fourth embodiment, when the inner tire 9 is dismounted from the wheel mounting cylinder 51 along the outer periphery of the rim spacer 55 or is mounted to the wheel mounting cylinder 51, the outer peripheral surface of the rim spacer 55 can be made to function as a guide surface, thereby making it possible to prevent a step from being produced between the fringe portion 54A of the outer rim 54 and the rim spacer 55. In addition, it is also possible to prevent a step from being produced between the thick-walled portion 52B of the inner rim 52 and the rim spacer 55.

It should be noted that, in the above-described fourth embodiment, a description has been given by citing as an example the case in which the rim spacer 55 is formed by a short-diameter tubular ring, and a plurality of inner rings 56 are provided on its inner peripheral side. However, the present invention is not limited to this particular example. For instance, the rim spacer may be constituted by using a tubular ring and the plurality of rail members as in the second embodiment shown in FIGS. 11 and 12. Furthermore, the rim spacer may be provided by bridging the inner rim and the outer rim as in the third embodiment shown in FIGS. 13 and 14.

In addition, in the foregoing embodiments, a description has been given by citing as an example the case in which the electric motor is used for, for instance, the traveling drive unit 10 on the rear wheel side as a drive source. However, the present invention is not limited to the same, and a hydraulic motor or the like, for instance, may be used as the drive source of the traveling drive unit. Further, the present invention is also applicable to a transportation vehicle of the type in which multiple tires are used on the front wheel side.

Furthermore, in the foregoing embodiments, a description has been given by citing the rear wheel drive dump truck 1 as an example. However, the present invention is not limited to the same, and may be applied to various transportation vehicles such as front wheel drive dump trucks or four-wheel drive dump trucks or the like in which front and rear wheels are driven together.

What is claimed is:

1. A transportation vehicle comprising:
a vehicle body on which a loading platform for carrying a load of transportation thereon is provided; a tubular axle housing provided on a lower side of said vehicle body in such a manner as to extend in a left-right direction; a pair of tubular wheel mounting cylinders respectively provided on both axial end sides of said axle housing; and left and right wheels which are respectively provided on said wheel mounting cylinders and rotate integrally with said wheel mounting cylinders,
each of said wheels including a plurality of rim bases provided on an outer peripheral surface side of said wheel mounting cylinder and arranged at an interval in the left-right direction and multiple tires which are respectively mounted by being detachably fitted to an outer peripheral surface side of each one of said rim bases and rotate integrally with said wheel mounting cylinder, characterized in that:
a rim spacer disposed between said rim bases to secure a clearance in the left-right direction between said tires is provided on the outer peripheral surface side of said wheel mounting cylinder, and said rim spacer is formed with an equivalent outside diameter dimension to that of said rim base located on an outer side in the left-right direction between said rim bases.

2. The transportation vehicle defined in claim 1, wherein a fitting ring which is slidably fitted on the outer peripheral surface side of said rim base is provided on an inside diameter side of at least said tire located at a position on an axially outer side of said wheel mounting cylinder between said multiple tires, and a lock ring which abuts against said fitting ring with an interference to effect the retaining of said tire is detachably provided on the outer peripheral surface side of said rim base.

3. The transportation vehicle defined in claim 1, wherein said plurality of rim bases are provided by being fitted to an outer peripheral surface of said wheel mounting cylinder.

4. The transportation vehicle defined in claim 1, wherein an annular disk is integrally provided on an inner peripheral side of said plurality of rim bases respectively, and each of said rim bases is provided by being fixed to said wheel mounting cylinder by tightening said disk to an outer peripheral side of said wheel mounting cylinder.

5. The transportation vehicle defined in claim 1, wherein a fitting ring which is located at a position on an axially outer side of said wheel mounting cylinder and is slidably fitted on the outer peripheral surface side of said rim base is provided on an inside diameter side of an inner tire between said inner tire and an outer tire constituting said multiple tires,
a pair of fitting rings which are respectively located on both axial sides of said wheel mounting cylinder and are slidably fitted on the outer peripheral surface side of said rim base are provided on an inside diameter side of said outer tire,
a lock ring which abuts against said fitting ring on a side of said inner tire with an interference to effect the retaining of said inner tire to an inner rim is detachably provided on an outer peripheral surface side of an inner rim between said inner rim and an outer rim constituting said plurality of rim bases, and
a pair of lock rings which respectively abut against said pair of fitting rings on a side of said outer tire with an interference to effect the retaining of said outer tire to said outer rim are detachably provided on an outer peripheral surface side of said outer rim.

6. The transportation vehicle defined in claim 1, wherein a plurality of inner rings which are fitted to an outer peripheral side of said wheel mounting cylinder are provided on an inner peripheral side of said rim spacer, and said rim spacer is held with an equivalent outside diameter dimension to that of said rim base by said inner rings.

7. The transportation vehicle defined in claim 1, wherein said rim spacer is constituted by a tubular ring which is formed with a substantially equal inside diameter dimension to a diameter of an outer peripheral surface of said wheel mounting cylinder and is fitted to an outer peripheral side of said wheel mounting cylinder and a plurality of rail members which project radially outward from an outer peripheral surface of said tubular ring and extend in an axial direction at intervals in a circumferential direction of said tubular ring, said rim spacer being formed with an equivalent outside diameter dimension to that of said rim base by said rail members.

8. The transportation vehicle defined in claim 1, wherein an annular tapered surface portion and a clamp are provided on an outer peripheral surface of said wheel mounting cylinder, said tapered surface portion being adapted to hold an inner rim between said inner rim and an outer rim constituting said plurality of rim bases in an axially retained state, said clamp being adapted to fix said inner rim, said rim spacer, and said outer rim in a retained and non-rotatable state by clamping said inner rim, said rim spacer, and said outer rim from both axial sides in cooperation with said tapered surface portion in a state in which said inner rim and said outer rim together with said rim spacer are fitted on an outer peripheral side of said wheel mounting cylinder, and
said rim spacer is held in a state of being clamped from the both axial sides between said inner rim and said outer rim on the outer peripheral side of said wheel mounting cylinder.

9. The transportation vehicle defined in claim 1, wherein an annular tapered surface portion and a clamp are provided on an outer peripheral surface of said wheel mounting cylinder, said tapered surface portion being adapted to hold an inner rim between said inner rim and an outer rim constituting said plurality of rim bases in an axially retained state, said clamp being adapted to fix said inner rim, said rim spacer, and said outer rim in a retained and non-rotatable state by clamping said inner rim, said rim spacer, and said outer rim from both axial sides in cooperation with said tapered surface portion in a state in which said inner rim and said outer rim together with said rim spacer are fitted on an outer peripheral side of said wheel mounting cylinder,
a pair of side rings and a fitting ring are provided on an inside diameter side of an inner tire between said inner tire and an outer tire constituting said multiple tires, said side rings being arranged in such a manner as to be spaced apart from each other in an axial direction of said wheel mounting cylinder, said fitting ring being secured to an inside diameter side of one side ring located on an axially outer side of said wheel mounting cylinder between said pair of side rings and being slidably fitted to an outer peripheral side of said rim base,
a pair of side rings and a pair of fitting rings are provided on an inside diameter side of said outer tire, said pair of side rings being arranged in such a manner as to be spaced apart from each other in the axial direction of said wheel mounting cylinder, said pair of fitting rings being respectively secured to an inside diameter side of each of said side rings and respectively slidably fitted on the outer peripheral side of said rim base,
a back flange and a gutter band are provided on said inner rim between said inner rim and said outer rim constituting said plurality of rim bases, said back flange abutting against said side ring located at a position on an axially inner side of said wheel mounting cylinder between said side rings on a side of said inner tire, said gutter band being slidably fitted to the outer peripheral surface of said wheel mounting cylinder and abutting against said tapered surface portion,
a lock ring detachably mounted on the outer peripheral surface side of said inner rim and abutting against said fitting ring on a side of said inner tire with an interference to effect the retaining of said inner tire to said inner rim in cooperation with said back flange is provided on said gutter band of said inner rim,
one gutter band located at a position on the axially inner side of said wheel mounting cylinder, slidably fitted to the outer peripheral surface of said wheel mounting cylinder, and fixed by said clamp is provided on said outer rim, while another gutter band is provided on said outer rim on the axially outer side of said wheel mounting cylinder,
a pair of lock rings which respectively abut against said pair of fitting rings on the side of said outer tire with an interference to effect the retaining of said outer tire to said outer rim are respectively detachably provided on said gutter bands of said outer rim, and
said rim spacer is held in a state of being clamped from the both axial sides between said gutter band of said inner rim and said one gutter band of said outer rim.

10. The transportation vehicle defined in claim 9, wherein notches are respectively provided in said gutter band of said inner rim and said one gutter band of said outer rim, whereby said rim spacer is held with an equivalent outside diameter dimension to those of said inner rim and said outer rim by said notches.
